(19) United States
(12) Patent Application Publication
(10) Pub. No.: US 2005/0135096 A1
(43) Pub. Date: Jun. 23, 2005

(54) Fresnel spotlight

(75) Inventors: Rudiger Kittelmann, Einbeck (DE); Harry Wagener, Alfeld (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Schott Glas

(21) Appl. No.: 10/915,785

(22) Filed: Aug. 11, 2004

(30) Foreign Application Priority Data
Dec. 22, 2003 (DE) 103 61 116.9-54

(51) Int. Cl. F21V 7/00

(52) U.S. Cl. 362/241

(57) ABSTRACT

A fresnel spotlight with an adjustable aperture angle of the emerging light beam, an ellipsoid reflector, a lamp, and at least one fresnel lens is provided. The fresnel lens includes a diffuser.

The invention relates to a fresnel spotlight with an adjustable aperture angle of the emerging light beam, having a preferably ellipsoid reflector, a lamp and at least one fresnel lens.

The parts relevant to lighting technology in conventional fresnel spotlights generally comprise a lamp, a fresnel lens and a spherical auxiliary reflector. The lamp filament is usually located essentially invariably at the center of the spherical reflector. Part of the light emitted by the lamp is therefore reflected back to it, and reinforces the light emission in the forward half-space. This forwardly directed light is collimated by the fresnel lens. The degree of collimation depends, however, on the distance between the fresnel lens and the lamp. The narrowest collimation is obtained when the lamp filament is located at the focal point of the fresnel lens. A quasi-parallel optical path, also referred to as a spot, is then obtained. The aperture angle of the emerging light beam can be increased continuously by shortening the distance between the fresnel lens and the lamp. A divergent optical path is then obtained, which is also referred to as a flood.

A disadvantage with such spotlights, however, is the poor luminous efficiency particularly in their spot setting, since only a comparatively small solid-angle range of the lamp is then picked up by the fresnel lens. A further disadvantageous effect results from the fact that much of the light reflected by the spherical reflector impinges again on the actual lamp filament, where it is absorbed and additionally heats the lamp filament.

DE 39 19 643 A1 discloses a spotlight with a reflector, a stop and a fresnel lens. With the spotlight, the illumination is altered by adjustment of the light source. This leads to a change in the brightness of the light. A distance adjustment between the vertex and the reflector, and between the stop and the reflector, is used for the brightness control.

DE 34 13 310 A1 discloses a spotlight with a lamp and a reflector, or a lamp and a converging lens. The spotlight furthermore has a diffuser or a mirror, both of which are positioned at an angle of 45°. The light is deflected by the mirror, and the light is scattered by the diffuser. A varying emission angle of the light beam is generated by displacement of the diffuser.

DE 101 13 385 C1 describes a fresnel spotlight in which the fresnel lens is a converging lens, whose focal point on the light-source side is located, in the spot setting, approximately at the ellipsoid reflector's focal point remote from the reflector. In this way, the lamp is not unnecessarily heated by light reflected back. Furthermore, both the distance ratio between the lamp and the reflector and the distance ratio between the reflector and the fresnel lens are adjusted interdependently by an elaborately configured guide. This, however, requires extra mechanical instruments.

With increasing miniaturization of the light source, for instance in the case of high-power high-pressure discharge lamps, however, an ever-more pronounced central dark region may occur in the output light field, which cannot be compensated for by scattering instruments inside the reflector, or can be compensated for by them only with large light losses. Even the conventional scattering instruments used to avoid imaging of the emission center of the light source can only provide limited help here, if any, since at least the dark central aperture cone then needs to be homogeneously illuminated in any setting of the fresnel spotlight. Particularly in the spot setting, however, this leads directly to large light losses since, although there is only a dark region with a very small aperture angle in this case, the full area of the fresnel lens is nevertheless used for scattering the light field in conventional fresnel lenses with scattering instruments.

It is an object of the invention to provide a fresnel spotlight which gives homogeneous output light with a high efficiency. This fresnel spotlight should also be straightforward and inexpensive to produce.

This object is surprisingly achieved by a fresnel spotlight as claimed in claim 1 and a lighting unit as claimed in claim 17.

The Inventors have discovered that these large light losses can be avoided in a surprisingly straightforward way by a diffuser. In this case, it is particularly advantageous for the fresnel lens to have a diffuser which, particularly preferably, is circularly designed and is arranged only at the center of the fresnel lens.

In this embodiment, the dark regions in the middle of the illumination field can be avoided very effectively in any setting of the fresnel spotlight, but the large light losses no longer occur in the spot setting of the reflector.

It has surprisingly been found that the geometrical-optical path of the light emerging from the reflector illuminates a smaller region at the position of the fresnel lens precisely whenever the required proportion of scattered light is increased.

The Inventors have utilized this effect in order to provide an automatic or adaptive light mixing system with the invention, by which, synchronously with the adjustment of the fresnel spotlight, only the scattered-light component that is needed for this setting is mixed in with the geometrical-optically imaged light.

The light mixing ratio, which can be adapted almost optimally to the light distributions required in each case, will be referred to for short as the mixing ratio in what follows.

This automatic light mixing system ensures the correct mixing ratio for essentially any setting of the reflector, and therefore consistently provides a very homogeneously illuminated light field, but without entailing unnecessary scattering losses.

In this case, the mixing ratio of the fresnel lens being illuminated surface-wide can be defined by selecting the diameter of the diffuser in proportion to the remaining area of the fresnel lens, and the aperture angle of the scattered light can be defined by the scattering properties of the fresnel lens.

The scattering effect may furthermore vary over the integrated diffuser itself so that, for example, more strongly scattering regions are arranged in the middle of the diffuser and less strongly scattering regions are arranged at its edge. A quite strongly focused light beam will be broadened further by means of this, and it is then possible to produce an extremely wide illumination angle.

As an alternative, not only may the edge of the diffuser be configured as ending abruptly, but it may also be configured with a scattering effect that decreases gradually, while continuing to extend under or over the fresnel lens. Further adaptations to the setting-dependent mixing ratios can be carried out by means of this.

In the preferred embodiments, the diffuser may be arranged either on the light entry side or on the light exit side. The advantageous option is furthermore available to arrange diffusers on the light entry and light exit sides. In the latter embodiment, it is even possible to use diffusers which scatter differently, for example ones which scatter differently as a function of position.

Reference is made to the Application entitled “Optical arrangement with fresnel lens” filed by the same Applicant on the same day, the disclosed content of which is fully incorporated by reference in the disclosed content of the present Application.

The uniformity of the illumination strength throughout the light field is preserved at the same time, as represented by way of example in FIG. 5 both for the spot setting and for a flood setting.

According to the invention, an ellipsoid reflector with a large aperture is provided. The spot setting is adjusted in that the lamp filament of a black-body radiator, in particular a halogen lamp or a discharge arc of a discharge lamp, is located at the ellipsoid's focal point on the reflector side, and in the ellipsoid's second focal point remote from the reflector is arranged approximately at the fresnel lens's real focal point close to the reflector.

Before entering the fresnel lens, the light reflected by the reflector is focused almost completely onto the ellipsoid's focal point remote from the reflector. The lamp filament located at the fresnel lens's focal point on the reflector side, or the discharge arc, is imaged at infinity after passing through the fresnel lens, so that its light is converted into an almost parallel light beam.

With an expedient selection of the aperture angle of the reflector and the fresnel lens, the light reflected by the reflector will be picked up almost completely by the fresnel lens and emitted forward as a narrow spot light beam.

In one embodiment of the invention, the ellipsoid reflector consists of a metallic or transparent dielectric material. Glass and polymeric materials, i.e. plastics, which may be coated with a metal, for example aluminum, are preferable used as dielectric materials.

As an alternative or in addition, in order to produce a reflective surface in an embodiment with a transparent dielectric material, one of the two surfaces of the reflector, or both of them, is coated with a system of optically thin layers. The coating of the fresnel lens preferably comprises a dielectric interference layer system, which alters the spectrum of the light passing through. By means of this, visible radiation components can advantageously be reflected and the invisible components, in particular thermal radiation components, can be transmitted.

In general, both the reflector, the fresnel lens and/or the diffuser may be coated on at least one side, for example with a scratch-resistant and/or antireflection layer in the case of plastic.

Another preferred embodiment of the invention comprises a metallic coating on one or both main surfaces of the reflector.

In another alternative configuration, the reflector may also be a metallic reflector which is either uncoated or dielectrically or metallically coated in order to provide the desired spectral and corrosion properties.

A preferred embodiment of the invention comprises a fresnel spotlight in which the light-reflecting surface of the reflector is structured, preferably with subsurfaces or facets, so as to scatter light, and none, one, or two of the surfaces of the fresnel lens are structured so as to scatter light. In this way, there is a fixed amount of scattered light superposition on geometrical-optically imaged light, which can reduce dark rings in the light field.

The fresnel lens is advantageously prestressed on its surface, preferably thermally prestressed, so as to have greater strength and thermal stability.

According to the invention, the spotlight may be used for medicine, architecture, cinematography, theater, studios and photography, and in a torch.

In the preferred embodiments, the diffuser may be arranged either on the light entry side or on the light exit side. The advantageous option is furthermore available to arrange diffusers on the light entry and light exit sides. In the latter embodiment, it is even possible to use diffusers which scatter differently, for example ones which scatter differently as a function of position.

The invention will be described in more detail with the aid of preferred embodiments and with reference to the appended drawings, in which:

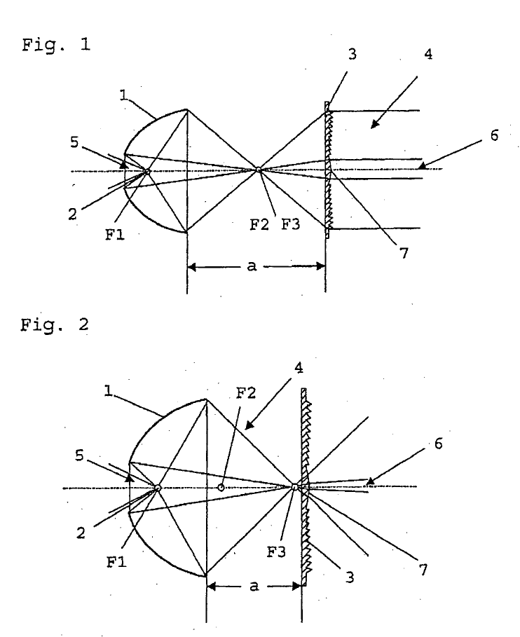

FIG. 1 shows an embodiment of the fresnel spotlight in the spot setting, the reflector's focal point remote from the reflector being superimposed approximately with the left-hand real focal point of the fresnel lens,

FIG. 2 shows the embodiment of the fresnel spotlight shown in FIG. 1 in a first flood setting, the reflector's focal point remote from the reflector being arranged close to a surface of the fresnel lens,

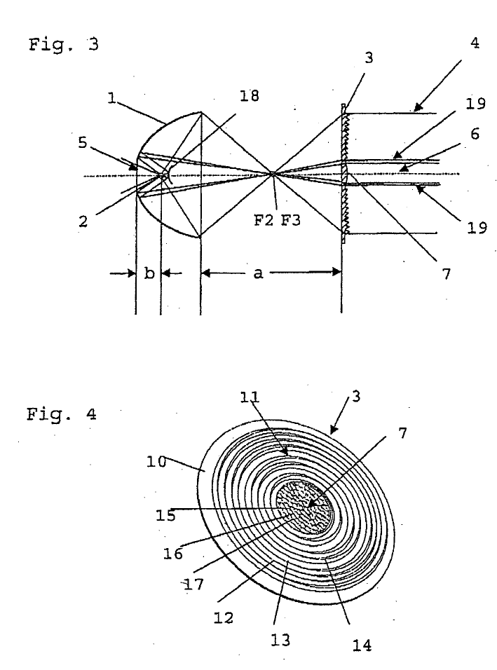

FIG. 3 shows the embodiment of the fresnel spotlight shown in FIG. 1 in a spot setting, with an auxiliary reflector by means of which a further part of the light is deflected first into the reflector and from there into the fresnel lens,

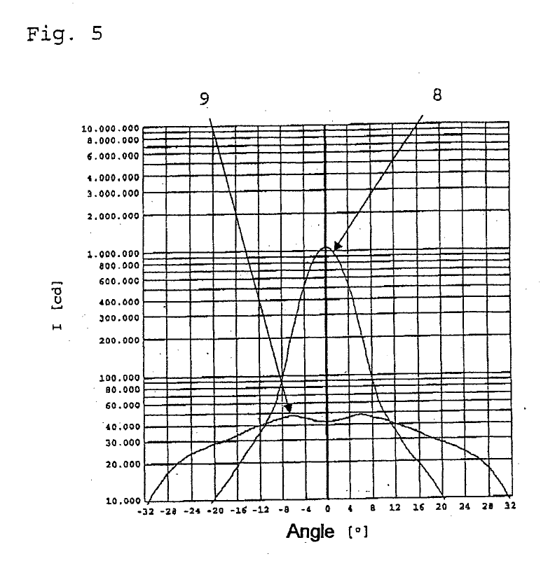

FIG. 4 shows a converging fresnel lens with a centrally arranged diffuser,

FIG. 5 shows an aperture angle-dependent logarithmic representation of the light strength of the fresnel spotlight in its spot setting and in one of its flood settings.

### DETAILED DESCRIPTION OF PREFERRED EMBODIMENTS

In the detailed description which follows, it will be assumed that the same reference numbers denote elements which are the same or have the same effect in the various respective embodiments.

Reference will now be made to FIG. 1, which shows an embodiment of the fresnel spotlight in a spot setting. The fresnel spotlight essentially contains an ellipsoid reflector 1, a lamp 2 which may be an incandescent lamp, in particular a halogen lamp, a light-emitting diode, a light-emitting diode array or a gas discharge lamp, and a fresnel lens 3, which is a converging lens, preferably a planoconvex fresnel lens.

In FIG. 1, the focal point F2 of the ellipsoid reflector 1, which is remote from the reflector, is superimposed approximately with the left-hand side real, or positive, focal point F3 of the fresnel lens 3.

The light beam 4 emerging from the spotlight is indicated merely schematically in the figures by its outer peripheral rays.

The distance a between the fresnel lens and the front edge of the reflector 1 is also represented in FIG. 1.

The spot setting is adjusted in that the lamp filament, or the discharge arc, of the lamp 2 is located at the focal point F1 of the ellipsoid reflector which is on the reflector side.

The light reflected by the reflector 1 is directed almost completely onto the focal point F2 of the ellipsoid 1 in this setting. The left-hand side positive, or real, focal point F3 of the fresnel lens 3 then coincides approximately with the focal point F2 of the reflector ellipsoid.

FIG. 1 also shows in the near-field how the opening 5 inside the reflector 2 causes a dark region 6 in the parallel optical path of the light field 4.

Inside the fresnel lens 3, there is a circular centrally arranged diffuser 7, which generates a defined scattered light ratio and a defined aperture angle of the scattered light. A defined mixing ratio of the scattered light relative to the light geometrical-optically imaged by the fresnel lens 3 is provided in this way.

As an alternative to this embodiment of the diffuser 7, in another embodiment, the scattering effect varies continuously along the radius of the diffuser 7, so that more strongly scattering regions are arranged in the middle of the diffuser 7 and less strongly scattering regions are arranged at its abruptly ending edge.

In yet another alternative embodiment, not only does the edge of the diffuser end abruptly but it is also designed with a scattering effect that decreases continuously, and it may also extend under or over the fresnel lens.

Further adaptations to the setting-dependent mixing ratios are carried out systematically by means of this, so that the person skilled in the art can always provide an optimum mixing ratio for a homogeneously illuminated light field, or even for light fields with higher local intensities generated in a defined way.

FIG. 1 furthermore shows that only a small part of the total light passes through the diffuser 7 in the spot setting.

The diffuser 7 leads to very homogeneous illumination, as illustrated for the spot setting by the line 8 in FIG. 5, which shows an aperture angle-dependent logarithmic representation of the light strength of the fresnel spotlight.

FIG. 2 shows the embodiment of the fresnel spotlight shown in FIG. 1 in a first flood setting, in which the focal point F2 of the reflector 1, which is remote from the reflector, is arranged approximately in a surface of the fresnel lens 3 which is close to the reflector.

By means of this, the value of the displacement a with respect to the spot setting is varied in a defined way by a mechanical guide.

The structure corresponds substantially to the structure of the fresnel spotlight explained in FIG. 1.

It can be seen clearly from FIG. 2, however, that both the aperture angle of the emerging light beam 4 and that of the dark region 6 have increased.

Yet, since a very high proportion of the light impinges only on a very small region in the middle of the diffuser 7 in this setting, this region may specifically be configured so that its forward scattering lobe approximately compensates in the desired way for the dark region 6 in the far-field or at long-range. Reference should also be made to FIG. 5, in which the line 9 illustrates the light ratios by way of example for a flood setting.

In one embodiment, the variation of the distance a may be carried out by hand, in which case an axial guide of the optical components may be used for this. As an alternative, the optical components may also be driven by a motor.

FIG. 3 shows another preferred embodiment. In this embodiment, which corresponds essentially to the embodiments described above apart from an additional auxiliary reflector 18, light from the lamp 2 which would propagate toward the right in FIG. 3, and would no longer reach the reflector 1, is deflected into the reflector 1 by reflection from the auxiliary reflector 18. In this way, not only is it possible to utilize the light which is represented merely by way of example by the optical path 19, and which would not contribute to the illumination without the auxiliary reflector, but it is also possible for the part of the light that otherwise directly enters the fresnel lens 3 to be utilized better for the desired light distribution.

The shape of the auxiliary reflector 18 is advantageously selected so that light reflected by it does not re-enter the light-generating means of the lamp 2, for example a filament or discharge zone, and unnecessarily heat it further.

As an alternative, the auxiliary reflector 18 may be fitted on the inside or outside of the glass body of the lamp 2. The glass of the lamp body may be appropriately shaped for this purpose, in order to achieve the desired directional effect for the reflected light.

FIG. 4 shows an example of a fresnel lens 3 with a diffuser 7, as used by the invention. The fresnel lens 3 has a transparent base body 10 and a fresnel lens ring system 11 with annular lens segments 11, 12, 13, inside which the circular diffuser 7 is arranged.

The diffuser 7 is structured in a defined way or has facets 15, 16, 17 with scattering behaviors that can be defined exactly in wide ranges, which are described in the German Patent Application DE 103 43 630.8 entitled “Diffuser” by the same Applicant, which was filed at the German Patent and Trademark Office on September 19. The disclosed content of that Application is fully incorporated by reference in the disclosed content of the present Application.

The invention is not, however, restricted to these previously described embodiments of diffusers.

The fresnel spotlight described above may be employed particularly advantageously in a lighting unit together with a substantially smaller electrical power supply or ballast device than in the prior art. For the same useable light power as in the prior art, this power supply may be made smaller both electrically and mechanically since the fresnel spotlight according to the invention has a much higher luminous efficiency. Less weight is therefore required and less space is taken up for transport and storage.

By means of this, particularly when cold-light reflectors are used, the overall thermal load exposure of the people and objects being illuminated is furthermore reduced.

The fresnel spotlight according to the invention may also be used advantageously to increase the luminous efficiency in torches.

### List of References

1 reflector
2 lamp
3 fresnel lens
4 emerging light beam
5 opening in the reflector 1
6 dark region
7 diffuser
8 intensity distribution in the spot setting
9 intensity distribution in the flood setting
10 base body
11 fresnel lens ring
12 annular lens segments
13 ditto
14 ditto
15 facet
16 ditto
17 ditto
18 auxiliary reflector
19 optical path reflected through the auxiliary reflector

1. A fresnel spotlight comprising:
an adjustable aperture angle of the emerging light beam;
an ellipsoid reflector;
a lamp; and
at least one fresnel lens, wherein the at least one fresnel lens has a diffuser.

2. The fresnel spotlight as claimed in claim 1, wherein the diffuser is circularly designed and arranged at the center of the at least one fresnel lens.

3. The fresnel spotlight as claimed in claim 1 er 2, wherein the at least one fresnel lens defines a light mixing system, which alters the proportion of the scattered light relative to the proportion of the geometrical-optically imaged light, and the light mixing ratio, as a function of the adjustable aperture angle.

4. The fresnel spotlight as claimed in claim 1, wherein the at least one fresnel lens has a real focal point, which can be superimposed with a focal point of the reflector.

5. The fresnel spotlight as claimed in claim 1, wherein the at least one fresnel lens is a planoconvex converging lens.

6. The fresnel spotlight as claimed in claim 1, wherein the at least one fresnel lens comprises a double lens with chromatically corrected imaging properties.

7. The fresnel spotlight as claimed in claim 1, wherein the reflector comprises a material selected from the group consisting of metal, transparent, dielectric material, glass, and plastic.

8. The fresnel spotlight as claimed claim 1, wherein the reflector comprises two main surfaces with a system of optically thin layers.

9. The fresnel spotlight as claimed in claim 1, wherein the reflector has a light-reflecting surface that is structured, so as to scatter light, and wherein the at least one fresnel lens has a number of surfaces that are structured so as to scatter light in addition to the diffuser, the number of surfaces being selected from the group consisting of zero, one, and two.

10. The fresnel spotlight as claimed in claim 1, wherein the at least one fresnel lens is a converging lens.

11. The fresnel spotlight as claimed in claim 1, wherein the reflector, the at least one fresnel lens and/or the diffuser are coated on at least one side.

12. The fresnel spotlight as claimed in claim 1, further comprising a coating on the at least one fresnel lens, the coating comprising a dielectric interference layer system, that alters the spectrum of the light passing through the at least one fresnel lens.

13. The fresnel spotlight as claimed in claim 8, wherein at least one of the two main surfaces of the reflector is coated with a metal.

14. The fresnel spotlight as claimed in claim 1, wherein the lamp is selected from the group consisting of an incandescent lamp, a halogen lamp, a light-emitting diode, a light-emitting diode array, and a gas discharge lamp.

15. The fresnel spotlight as claimed in claim 1, further comprising an auxiliary reflector arranged between the at least one fresnel lens and the reflector.

16. The fresnel spotlight as claimed in claim 1, wherein the at least one fresnel lens includes a thermally prestressed surface.

17. A lighting unit comprising:
an emerging light beam having an adjustable aperture angle;
an ellipsoid reflector;
a lamp;
a fresnel lens having a diffuser; and
an associated electrical power supply or ballast device.

18. The lighting unit as claimed in claim 17, wherein the unit is adapted to be used in a discipline selected from the group consisting of medicine, architecture, cinematography, theater, studios, and photography.

19. A torch comprising:
an emerging light beam having and adjustable aperture angle;
an ellipsoid reflector;
a lamp;
a fresnel lens having a diffuser; and
an electrical power supply or ballast device.
